(19) United States
(12) Patent Application Publication
(10) Pub. No.: US 2002/0184055 A1
(43) Pub. Date: Dec. 5, 2002

(54) System and method for healthcare specific operating system

(76) Inventors: Morteza Naghavi, Houston, TX (US); Mohammad Madjid, Houston, TX (US); Parsa Mirhaji, Houston, TX (US); Reza Mohammadi, New York, NY (US); David J. Robinson, Houston, TX (US)

Correspondence Address: Gary R. Maze, Duane Morris LLP, One Greenway Plaza, Suite 500, Houston, TX, 77046, US

(21) Appl. No.: 10/157,560

(22) Filed: May 29, 2002

Related U.S. Application Data
(60) Provisional application No. 60/294,040, filed on May 29, 2001.
(60) Provisional application No. 60/293,965, filed on May 29, 2001.
(60) Provisional application No. 60/293,964, filed on May 29, 2001.
(60) Provisional application No. 60/293,897, filed on May 29, 2001.

(51) Int. Cl. G06F 17/60

(52) U.S. Cl. 705/2

(57) ABSTRACT

A system and method of providing operating system functionality for a healthcare specific computer operating system for a computer system is disclosed. The method comprises initiating a predetermined set of basic input/output system routines; scanning a predetermined set of data ports for the existence of a medical device; initializing a driver for the medical device upon detection of the medical device, the driver providing access between the predetermined set of basic input/output system routines and the medical device; initializing a graphic user interface, the graphic user interface executing on the computer system and interfacing to the predetermined set of basic input/output system routines; determining a status of a predefined health status condition of a user of the healthcare specific computer operating system; and mutating a desired mutatable characteristic of a displayed graphic user interface element based on a predefined health status condition of a user of the healthcare specific computer operating system. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### RELATION TO OTHER APPLICATIONS

The present invention claims priority from U.S. Provisional Application No. 60/294,040 filed May 29, 2001, U.S. Provisional Application No. 60/293,965 filed May 29, 2001, U.S. Provisional Application No. 60/293,964 filed May 29, 2001, and U.S. Provisional Application No. 60/293,897 filed May 29, 2001.

### BACKGROUND OF THE INVENTION

In the United States alone, over one hundred million people have chronic health conditions. For example, twenty four percent of the US adult population (representing 43,186,000 persons) has hypertension, nearly one third of them even do not know that they have hypertension, and nearly three-fourths are not controlling their blood pressure.

Patients who are uncertain about their signs and symptoms often have a significant and fatal delay on seeking medical treatment and many of them die before reaching the hospital. It appears that within an average month in the United States, 75% of adult population experience an episode of illness or injury but only 17% of them consult a physician at all.

However, nearly 70% of the chest pain presentations to US emergency departments are ultimately diagnosed with non-specific chest discomfort. This disturbing statistic places a huge financial burden on the healthcare industry.

Technological advances now enable a number of services that once required hospitalization to be performed in a regular in-home basis. The medical devices industry is aggressively moving towards facilitating a home healthcare system that will further expand the number of disease states which can be treated at home. However, the recent technical evolution in both medical devices and information technology had its least effects on home based healthcare management, in part because providing automated and sophisticated medical assistance to patients and families at home is a very complex and yet unexplored area.

Ideas have been forwarded and efforts made to facilitate providing advanced healthcare services at home. Prior attempts to deliver home based healthcare management and monitoring services were based on providing a remote healthcare monitoring system. They have included the use of personal computers and modems to establish communication between patients and healthcare facilities. Similar attempts to establish communication between patients and healthcare providers have included the use of the Internet and Internet terminals. Other attempts to monitor patients remotely have included the use of medical monitoring devices with built-in modems. Examples of such monitoring devices include blood glucose meters, respiratory flow meters, and heart rate monitors. Unfortunately, these monitoring devices are only designed to collect physiological data from the patients. They do not allow flexible and dynamic querying of the patients for other information, such as quality of life measures or psychosocial variables of illness. Prior attempts to monitor patients remotely have also included the use of interactive telephone or video response systems.

Such interactive systems are disclosed in U.S. Pat. Nos. 5,997,476; 6,144,837; 5,827,180; 5,390,238; 5,434,611; 5,441,047; 5,410,471; 6,171,237; 3,910,257; and European Pat. No. EP00251520A2.

One disadvantage of these systems is that they either require a patient to call in to a central facility to be monitored or require the central facility to call the patient according to a rigid monitoring schedule. They also need to provide patients with specialized medical and communication instruments, developed specially for a certain healthcare facility or are specialized only in a certain disease or healthcare conditions. Most of these remote services are concerned in reducing general costs and expenditures of the healthcare providers and pharmaceuticals and providing the healthcare information for them rather than providing a comprehensive healthcare management service at home.

In the same time others attempted to provide a solutions to connect PC systems and medical devices, to employ the processing and networking functionality a PC could add to a certain medical device. Examples of such efforts are disclosed in U.S. Pat. Nos. 5,594,637; 6,171,154; 4,803,625; 5,704,366; 5,307,263; 5,024,225; and 4,290,114. These references are limited in scope with respect to coverage of healthcare data.

Every medical device had its own characteristics and needed a specially configured computer system to communicate with. On the other hand most of the attempts are concerned in data acquisition and communication of limited health data types to a certain application or to a certain remote center on the Internet. There are also attempts made to build a system for managing administration of medical treatment regimens for treating a patient's medical conditions, disclosed in U.S. Pat. No. 6,085,752; European Patent No EP01011433A1; and WIPO Patent No W009838909A1. The method and system disclosed in these inventions creates an integrated environment for managing an specific field of healthcare management by a certain firm of physicians or healthcare workers. The invention doesn't provide an standard and integrated solution in the field of personal healthcare management focused on providing an open platform based on existing technology of computing, communication and treatment without any dependency to a certain entity or limited in a certain field of healthcare management. There still is a need for a comprehensive solution to integrate whole aspects of the personal healthcare management, healthcare education as well as treatment and medication, health data exchange as well as community based support groups.

The present invention discloses a healthcare specific operating system for personal computers dedicated and specifically developed for personal healthcare management. In addition to the basic compartments of an operating system, the specialized healthcare operating system possesses a comprehensive collection of drivers and software components to automatically recognize, control and work with a variety of home based medical devices attached to a personal computer and professionally manage the health data. The specialized healthcare operating system employs an enhanced health-specific graphical user interface (GUI).

### BRIEF DESCRIPTION OF THE DRAWINGS

FIG. 1 is a schematic diagram of a system according to the present invention;

FIG. 2 is a schematic diagram of a system according to the present invention in a deployed embodiment;

FIG. 3 is a schematic overview of a specialized operating system of the present invention;

FIG. 4 is a schematic representation of a modeling method of the present invention involving physician cognitive engineering;

FIG. 5 is schematic representation of a modeling method of the present invention involving risk stratification;

FIG. 6 is an exemplary presentation of an exemplary heartfolio;

FIG. 7 is an exemplary presentation of an exemplary interaction questionnaire;

FIG. 8 is a plan view in partial representative of an exemplary medical device and sensor;

FIG. 9 is a plan view in partial representative of an exemplary integrating device;

FIG. 10 is a plan view in partial representative of a second exemplary integrating device;

FIG. 11 is a diagrammatic representation of a method of use of the present invention; and

FIG. 12 is a diagrammatic representation of a method of use of the present invention.

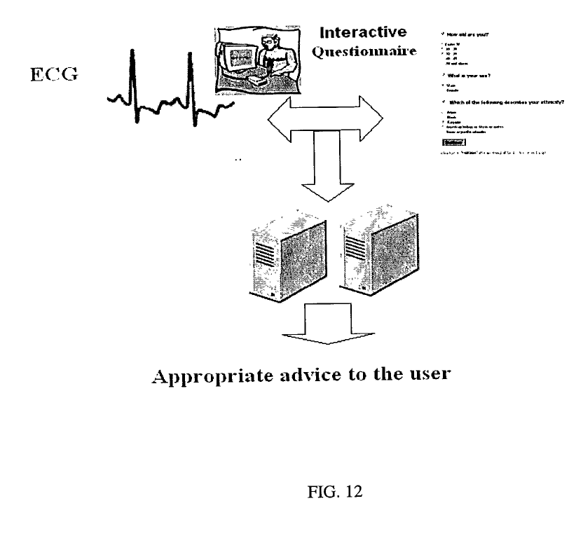

### DETAILED DESCRIPTION OF AN EXEMPLARY EMBODIMENT

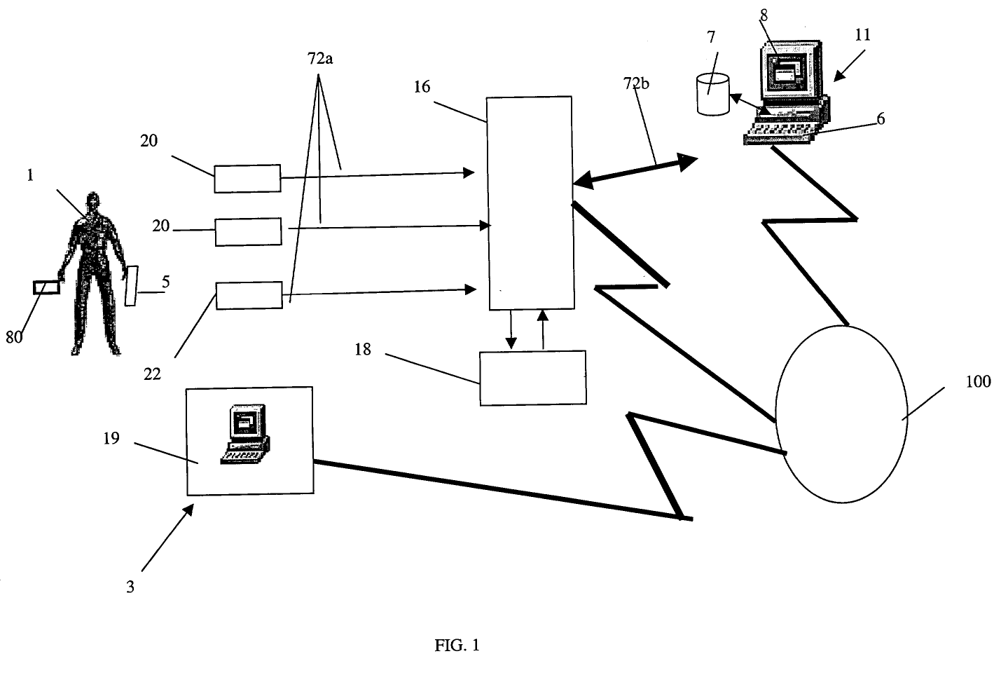

Referring now to FIG. 1, a generalized schematic of an exemplary embodiment, the present invention, generally referred to herein as personal healthcare management system 10, comprises components that work together to provide an out-of-hospital, affordable, real time, automated intelligent system for early managing and risk stratifying of patients 1 based on their symptoms, physiologic data (ECG, BP) and their past medical history. As used herein, “home” and “home-based” are understood to broadly mean locations that are not hospitals or other clinical facilities. Further, although the exemplary embodiment is described in terms of cardiac care and heart related symptoms and measurements, the present invention is not limited to cardiac care.

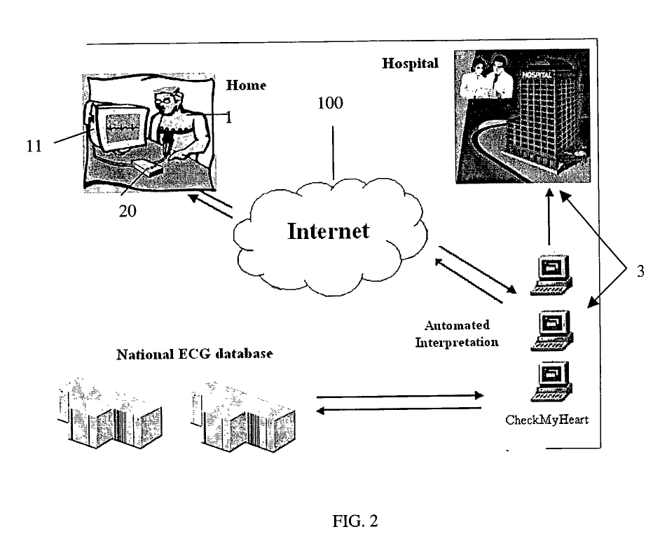

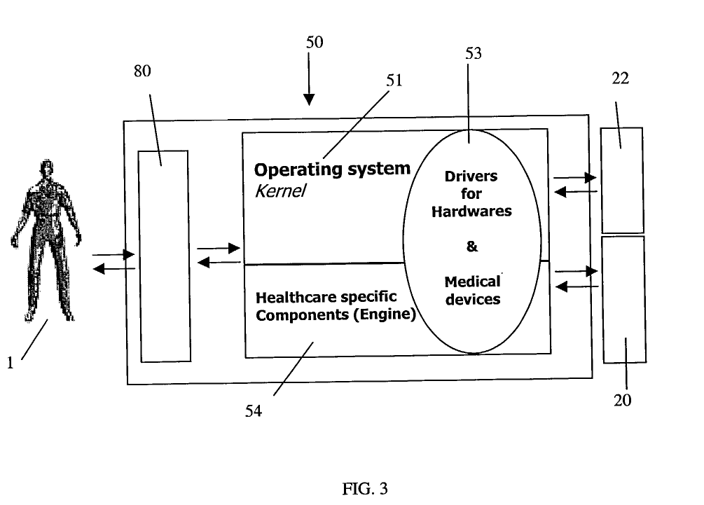

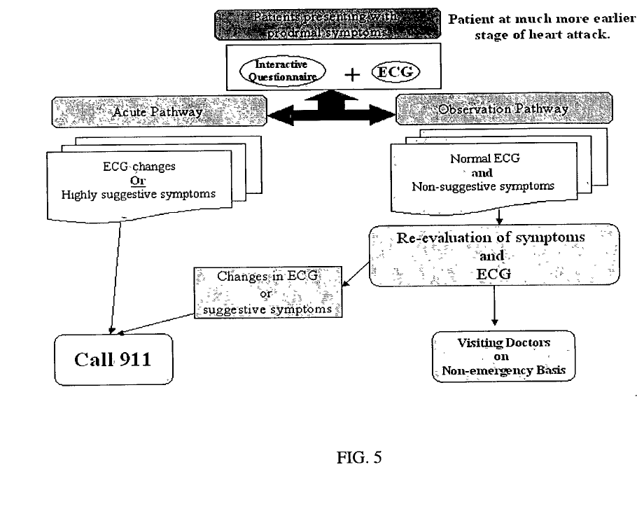

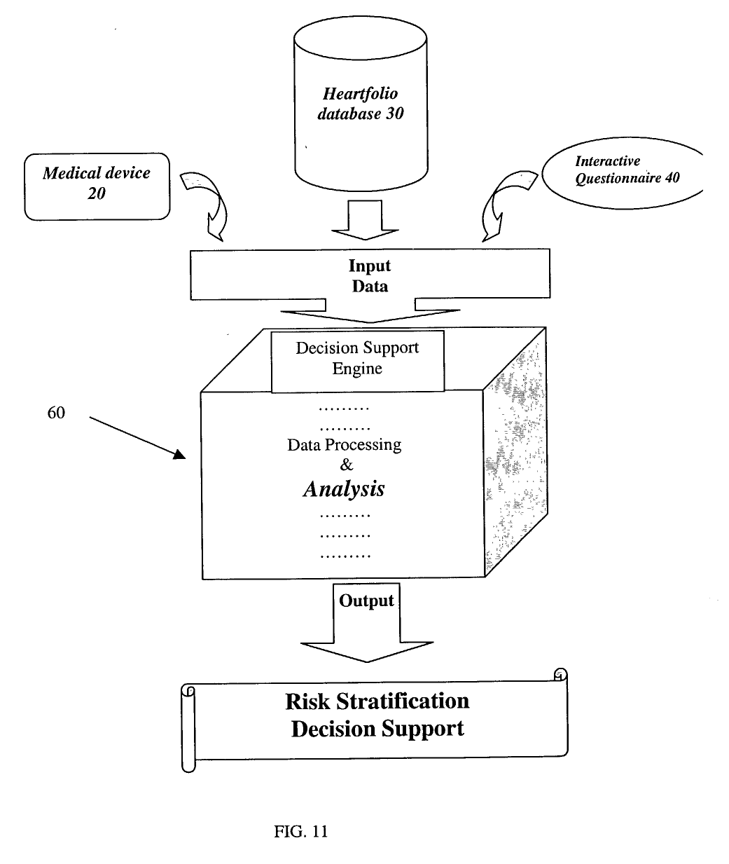

Personal healthcare management system 10 comprises computer 11 comprising input device 6, e.g. a mouse, keyboard, biometric input, microphone, and the like; persistent data store 7 such as fixed or removable magnetic, electronic, and/or optical media, and output device 8 such as a monitor. As used herein, computer 11 may comprise a personal computer, a personal digital assistant, a handheld computer, a laptop computer, or the like. Personal healthcare management system 10 further comprises healthfolio 31 (FIG. 2), heartfolio database 30 (FIG. 11), interactive questionnaire 40 (FIG. 3), medical device 20, specialized healthcare operating system 50 (FIG. 5), and medical diagnostic software 60.

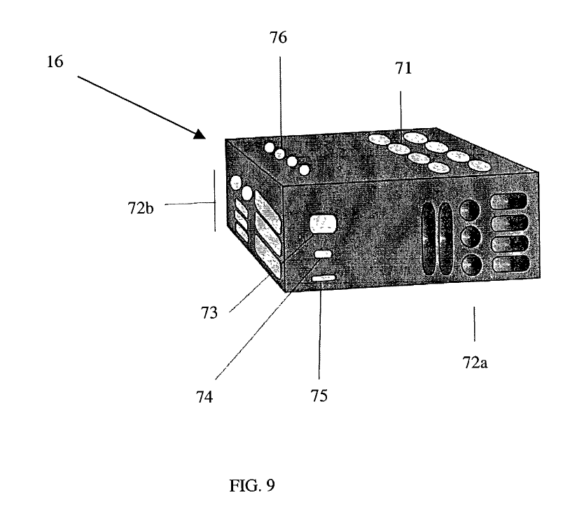

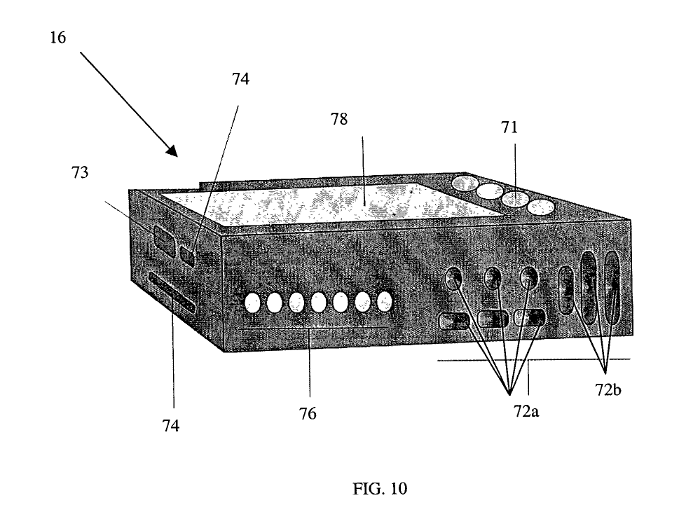

Personal healthcare management system 10 comprises computer 11 operatively in communication with one or more home-based medical devices 20 including sensors 22. Personal healthcare management system 10 may also provide a full-featured personal computer environment in which third party applications may be installed and invoked. Specialized healthcare specific operating system 50 operates on personal healthcare management system 10. Additionally, personal healthcare management system 10 may comprise communication link 12 (not shown in the figures), expansion port 14 (not shown in the figures), and integrating device 16 (FIG. 9 and FIG. 10). Interactive user control module 5 (FIG. 1) and programmable remote paging device 80 (FIG. 1) may also be provided.

Computer 11 provides standard personal computer functionality and may be implemented using standard personal computer technology, e.g. input device 6 such as a keyboard, output device 8 such as video display, a CPU, memory such as RAM memory, and persistent data store 7 such as a fixed or removable electronic, magnetic, and/or optical medium.

Personal healthcare management system 10 may further comprise communication link 12 to allow data communication over public or private data networks 100, e.g. the Internet, local area networks, telephone or cellular phone network, cable systems, and the like, or combinations thereof.

Personal healthcare management system 10 can automatically recognize and simultaneously control and acquire data from a plurality of medical devices 20. Medical devices 20 may be operatively in communication with personal healthcare management system 10 via wired or wireless communication links, e.g. serial, parallel, USB, infrared, flashcard, PCMCIA, SCSI, BlueTooth®, or IEEE 1394 ports, or the like, or combinations thereof.

In addition, medical devices 20 and/or sensors 22 may be attached to personal healthcare management system 10 via a specially designed expansion-hosting device such as an external integrating device 16. Additionally, expansion-hosting device 16 may comprise expansion port 14 (not shown in the figures) that can host assembly housing 24 (not shown in the figures) comprising a plurality of medical devices 20,22 and/or specially designed integrating device 16 connected to a plurality of medical devices 20,22. For example a digital pregnancy tester, a glucometer and a digital urine analyzer can be packed together into assembly housing 24 and attached to personal healthcare management system 10 through expansion port 14.

Other manufacturers may use an internal version of integrating device 16 and internal versions of medical devices 20 assembled together into a single housing. For example, to turn a notebook computer system to personal healthcare management system 10, a PCMCIA version of integrating device 16 can be used with a notebook computer to integrate medical devices 20 and help turn the notebook computer into personal healthcare management system 10.

Medical devices 20 may be internal or external to personal healthcare management system 10 and may comprise an electrocardiograph device, a blood pressure measurement device, thermometers, digital biochemical devices, glucometers, and physiological laboratory kits, digital biomechanical monitoring devices, peak-flow meter, and the like, or combinations thereof. Additionally, medical devices 20 may be external or internal to personal healthcare management system 10.

A variety of sensors 22 for obtaining biophysical, biomechanical, physiological, biochemical, and electromechanical parameters, e.g. ECH electrodes, may be used to connect patients to personal healthcare management system 10 through a wired or wireless communication links, e.g. serial, parallel, USB, infrared, or IEEE 1394 ports, or the like, or combinations thereof. For example, a wireless bra may be used where the wireless bra comprises one or more sensors 22 which transmit data obtained from patient 1, e.g. from an ECG electrode, a digital stethoscope, and a digital thermometer integrated inside the wireless bra.

Additionally, processor 18 may be used to interface with computer 11 and be coupled with integrating device 16 acting as a signal conditioner module to aid in integrating medical devices 20 with computer 11. Integrating device 16 may be used as a signal conditioner module to condition data inputs when coupling medical devices 20 into computer 11 and/or processor 18.

Personal healthcare management system 10 utilizes interactive user control module 5 (FIG. 1) to facilitate interaction between patient 1 and personal healthcare management system 10. User control module 5 (FIG. 1) may be accessed by patient 1 using any of numerous functionally equivalent input devices, e.g. a touch screen, a touch pad, speech synthesis via a microphone, keyboards, mice, recognition devices, remote controls, biometric devices, and the like or combinations thereof. Interactive user control module 5 (FIG. 1) may be implemented as a device an externally attachable to personal healthcare management system 10 or can be built in the same physical system assembly of personal healthcare management system 10. Moreover, personal healthcare management system 10 may possess more than one embodiment of interactive user control module 30. For example, interactive user control module 5 (FIG. 1) can use a built-in touch screen and a remote control.

Interactive user control module 5 (FIG. 1) may be further tailored for a specific healthcare condition of patient 1 and/or configuration of personal healthcare management system 10. For example, interactive user control module 5 (FIG. 1) may be specially designed as a touch screen for an elderly patient 1, as a speech sensitive device for a debilitated patient 1, or integrated into specially designed portion of furniture such as a sliding side panel for personal computer integrated into a bed or couch.

Additionally, interactive user control module 5 (FIG. 1) may be used to facilitate access to one or more predefined functions of personal healthcare management system 10. For example, interactive user control module 5 (FIG. 1) may comprise a remote control device (not shown in the figures) with one or more dedicated buttons or keys. These dedicated keys or buttons may be assigned to a specific function or group of functions, e.g. instant 911 dialer, instant ECG recording, instant medical record preview, or the like.

By way of further example, a couch employing the present invention may comprise joints and gears sufficient to further extend the couch into a bed, allowing patient 1 to lie on the extended couch comfortably while personal healthcare management system 10 is running ECG monitoring. Sensory devices 22, display 8, and interactive user control module 5 (FIG. 1) may then be designed and built into the couch, e.g. in a automatically launched, hidden box within the couch. Patient 1 can also use personal healthcare management system 10 as a healthcare management device or as an ordinary PC, comfortably while sitting on the couch.

Additionally, access to personal healthcare management system 10 may be accomplished using programmable remote paging device 80 (not shown in the figures). This allows patient 1 to be connected to and/or monitored by personal healthcare management system 10 when patient 1 is not located proximate personal healthcare management system 10. Programmable remote paging device 80 may be implemented in a plurality of designs and forms according to the comfort and health condition requirements of patient 1. For example, programmable remote paging device 80 may be a conventional paging device, an eyeglass or earring-like paging device comprising a speaker or beeper, a watch-like device comprising vibrator, and the like, or combinations thereof.

Personal healthcare management system 10 may be used to support a variety of automated paging strategies which may be employed to automatically send or route notifications to or from patient 1 or another, e.g. a physician, using these paging strategies. For example, personal healthcare management system 10 may be configured to automatically call a predefined phone number to notify a designated person or entity about a healthcare event. Programmable paging devices 40 may perform a plurality of different alerting actions, e.g. blink, beep, talk through a speech synthesis device, vibrate, and the like, These may be invoked according to a pre-defined set of configurable criteria.

Referring now to FIG. 2, personal healthcare management system 10 gathers necessary information of patient 1 such as past medical history, symptoms, risk factors, ECGs, and the like, and stores them in heartfolio database 30. Specialized healthcare operating system 50 may submit required health data acquired from different sources and applications or by patient 1 directly into the compilation of healthfolio 31. Health data acquired by a certain medical device 20 in a certain application environment may be accessible to other healthcare applications or for communication through data network 100.

In a preferred embodiment, heartfolio database 30 is a secure, HIPAA (Health Insurance Portability and Accountability Act) compliant database. For example, specialized healthcare operating system 50 may provide security and privilege verification before accessing healthcare and medical data.

Specialized healthcare operating system 50 may therefore provide security features, multi-user environment, networking support, multitask and multi-thread processing and multimedia support.

Personal healthcare management system 10 uses the stored information to create a updateable personalized portfolio 31, e.g. a cardiac portfolio 31, for each patient 1. Personal healthcare management system 10 may be accessible through data network 100, e.g. the Internet, where such access may be via dialup, DSL, satellite, or other data communications to a clinical location such as hospital 2 or a service which can provide most if not all of the functionality of personal healthcare management system 10 to patient 1 when personal healthcare management system 10 is not otherwise available to patient 1, e.g. remote service 3. Personal healthcare management system 10 processes the current symptoms, past medical clinical information 30 of patient 1 and dynamic physiologic data for risk stratification and management of patient 1 and creates an output based on the all available information for patient 1. Generated results may include real time risk stratification and automated emergency, e.g. 911, activation, or transmitted pertinent cardiac information to hospitals or health care providers, or other interested parties.

Personal healthcare management system 10 is customizable, containing baseline data not available to hospitals since patient 1 can store baseline data prior to the onset of an acute event. This output ranges from simple patient advice to more sophisticated actions like activating an alarm system or informing health care provider automatically. The invention can provide therapeutic actions such as perform cardioversion as an automated external defibrillator.

Additionally, personal healthcare management system 10 may have access to alternative databases such as a national ECG database 33.

Referring now to FIG. 3, specialized healthcare specific operating system 50 comprises one or more drivers and software components as well as a specially designed healthcare specific graphical user interface to automatically recognize, and work with, medical devices 20,22. Additionally, specialized healthcare specific operating system 50 presents an interface 80 to aid in guiding patient 1 through predetermined functions of specialized healthcare specific operating system 50.

Specialized healthcare operating system 50 may be installed and used in standard computers 11 (FIG. 1), e.g. desktop computers, laptop and notebook computers, handheld computers, and the like. In a preferred embodiment, in addition to incorporating basic input/output system routines 51 and utilities found in certain existing personal computer operating systems, specialized healthcare operating system 50 possesses a comprehensive collection of drivers and software components 53 to automatically recognize, control, and work with a variety of home based medical devices 20 attached to personal computer 11 and manage health data.

Drivers 53 support a wide variety of medical devices 20 and enable specialized healthcare operating system 50 to efficiently connect and interact with medical devices 20. Specialized healthcare operating system 50 can include a specific driver 53 for each medical device 20 or can include general drivers for divers types of medical devices 20.

Specialized healthcare operating system 50 contains a collection of re-usable and shared components, application programming interfaces (API) and applications based on the medical and healthcare standards and protocols, generally referred to as “54” in FIG. 3. Application programming interfaces and shared components are publicly accessible for programmers and system developers. APIs and shared components may be based on standard definitions such as offered by authorized organizations like ANSII, IEEE, American Society Of Testing And Materials (ASTM), Health Informatics Standards Planning Panel (HISPP), Message Standards Developers Subcommittee (MSDS) and the like. Accordingly, support for standards like X12, HL7, DICOMM, and medical logic modules (MLM) may be provided. Medical standards supported by specialized healthcare operating system 50 help assure standardization, security, interoperability and efficient data exchange between diverse healthcare applications and medical devices 20 built on this platform and create a rich software platform for developing new generation of robust healthcare management applications along with a more comprehensive health folio.

Specialized healthcare operating system 50 can also provide a full-featured conventional operating system environment to access ordinary functions of an ordinary PC through health-specific GUI 80 (read, write, execute, etc). In an embodiment, specialized healthcare operating system 50 comprises a full-featured operating system with multimedia support, networking support, multi-user environment, security features, multi-tasking and multithreading capabilities. Specialized healthcare operating system 50 may therefore be used as a platform for a variety of software applications already developed for conventional operating system environments.

In an embodiment, specialized healthcare operating system 50 is exclusively designed and developed as a health-care specific operating system. All drivers 53, software components 54, and GUI 80 are designed and developed exclusively for specialized healthcare operating system 50. In a further embodiment, specialized healthcare operating system 50 is a healthcare specific operating system adapted from an existing operating system platform, e.g. Microsoft® Windows®, Linux, Apple® Macintosh®, and the like. In these embodiments, the hosting operating system and GUI 80 are rebuilt and additional components are added. All of these are then reintegrated to create specialized healthcare operating system 50.

In yet a further embodiment, a software package is installed on an existing operating system. This software package adds all of the additional components required to turn the existing operating system into specialized healthcare operating system 50 without changing the hosting operating system. In this embodiment, an executable from the package will simulate health-specific GUI 80 and will mask the native GUI 80 of the hosting operating system.

Additionally, different embodiments of specialized healthcare operating system 50 may be customized for different domains of healthcare management.

In a preferred embodiment, specialized healthcare operating system 50 operates on a standalone personal computer hardware platform and can operate the standalone personal computer hardware platform without any medical device 20 installed. In other embodiments, specialized healthcare operating system 50 may provided for networked healthcare management systems, where health data are created and collected in multiple points such as over a local area network.

Specialized healthcare operating system 50 employs an enhanced dynamic and interactive healthcare specific graphical user interface, GUI 80. The health-specific GUI 80 is healthcare oriented and embodies a new concept in developing dynamic and interactive personally customizable user interfaces which permits taking in information without reading and actively supports a set of predetermined healthcare management concepts by itself.

Healthcare specific GUI 80 employs a unique and proprietary technique of arranging icons and menus in a display area such as display 8 (FIG. 1) and comprises health objects (not shown in the figures), i.e. healthcare-specific basic components based on healthcare related concepts. Healthcare specific GUI 80 dynamically changes and orders the display of icons, health objects, and menus according to a personal health condition and schedule, presents a comprehensive healthcare information portal, presents a variety of disease specific healthcare applications, forms a visual and personal healthcare portal, and interactively guides patients 1 through a healthcare portal. As used herein, an exemplary healthcare portal may comprise the following services: a healthcare related medical contacts buddy list, e.g. using medical contact buddy list patient 1 can send email messages or communicate online (instant messages, teleconferencing, voice chats) while both parties are online; healthcare directory search engine, e.g. one that automatically communicates with Internet services to update patient 1 with the healthcare directory information obtained from a personally customizable, filterable provider of service availability data and information according to personal configuration or in a disease base such as a system to help patient 1 find specific insurance packages, special home based medical devices 20, find special educational or paramedical course concerning a certain disease or healthcare condition or any personal configuration; personal healthcare information digests which may comprise personally customizable and disease oriented portals of the information automatically updated by specialized healthcare operating system 50 to provide patient 1 with a variety of state of the art healthcare related information in a categorized and easy to use format, e.g. healthcare professionals' white pages, healthcare channels on the Internet, healthcare facilities yellow pages, healthcare related newsgroups and discussion groups, healthcare related products and shopping, healthcare news and headlines, healthcare Insurance services and packages, current researches and new technologies, healthcare international organizations and institutions, healthy nutrition facts and recipe of the day, and healthy life style information, or the like.

The collected predetermined set of healthcare related functions, e.g. 54, are processed into an easy-to-access and user friendly GUI 80 graphical display. Patient 1 may then use GUI 80 to find those selectable items needed in a single visual display of displayed items comprising menus, health objects, icons, and options. The displayed items may comprise options for healthcare related communications, e.g. create a buddy list based on personal medical contacts list; healthcare information and news; healthcare management and treatment applications and healthcare directory services; drug information; and the like. The items may thus be presented in an integrated environment.

GUI 80 may further change and show different types of icons and health objects according to different diseases and/or other physical conditions of patient 1. The icons and health objects may change in color, shape, order, or other mutatable attribute according to different time schedules and severity or degree of some of findings, e.g. the shape, size, color, and relative position of each icon can change according to a current health status and health plan of patient 1.

GUI 80 can also provide a conventional personal computer environment as needed, temporarily masking health specific GUI 80 behind a more conventional user interface. In a preferred embodiment, healthcare tasks and functions of specialized healthcare operating system 50 remain active and running while GUI 80 is in a conventional personal computer mode.

GUI 80 may further include basic components, e.g. My Prescriptions which allows viewing and manipulation of medication, My Personal Visits which allows viewing and manipulation of calendars, My Medical Contact which allows viewing and manipulation of contact information, an emergency phone dialer, My Healthfolio which allows viewing and manipulation of personal health data, My Schedule Today which also allows viewing and manipulation of calendars, and the like. In addition, GUI 80 can adopt more than one selectable profile, i.e. a different embodiment of GUI 80 with variety of interface logic to support an predetermined set of health care characteristics. For example, a profile can be tailored to a specific disease for patient 1 or a variety of interfaces the same disease as may be used by a physician.

GUI 80 may additionally be equipped with speech synthesis and speech recognition technology to employ audio-visual interactions.

In a preferred embodiment, GUI 80 is interactive and dynamic, and may automatically detect changes in health status and health plan for patient 1 and automatically react and rearrange the available options to best suit the condition of patient 1.

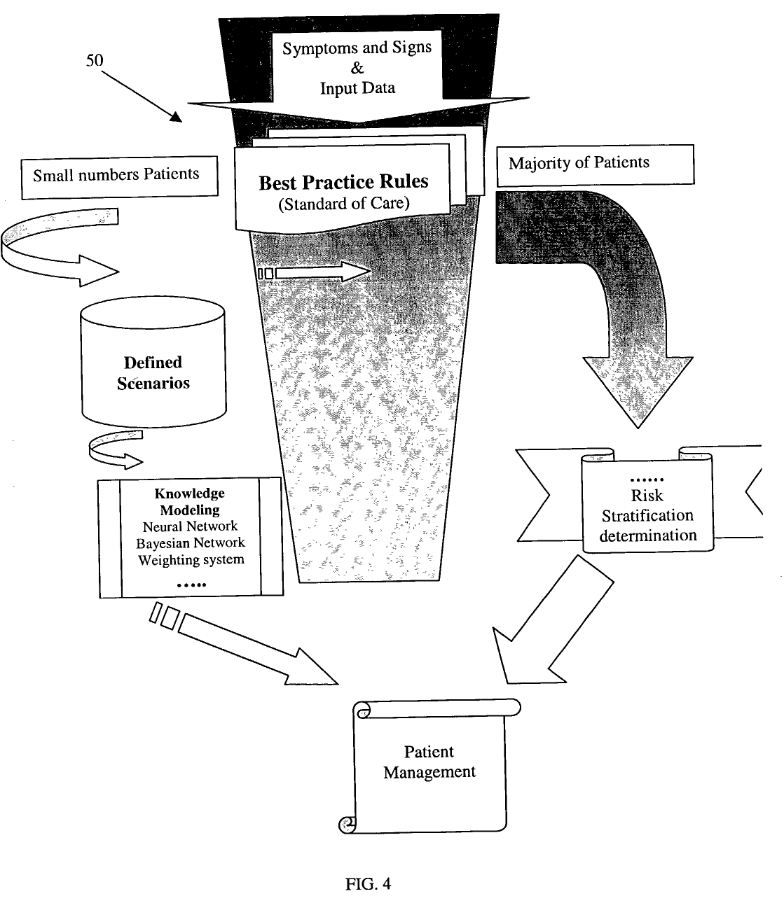

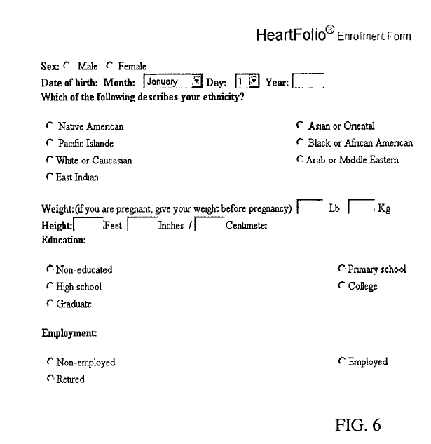

Referring now to FIG. 4, specialized healthcare operating system 50 possesses comprehensive disease based management protocols according to the best clinical practice algorithms and physician driven protocols. Specialized healthcare operating system 50 provides patients with virtual visits at home using management protocols. During a virtual visit, specialized healthcare operating system 50 starts a personally customized set of data acquisitions through medical devices 20 (FIG. 1) and a personalized complications, signs, and symptoms questionnaire to obtain the health data, e.g. hearthfolio 31 (FIG. 6). Specialized healthcare operating system 50 may compare acquired data against healthfolio 31 for patient 1 and simulate a healthcare data analysis using Physician Cognitive Engineering and/or Cardiology Cognitive Engineering such as would be experienced by patient 1 if patient 1 happened to be present in a best practicing healthcare facility.

Referring now to FIG. 5, specialized healthcare operating system 50 may provide patient 1 with sophisticated medical recommendations according management protocols and helps patient to act according the recommendations. Specialized healthcare operating system 50 may include a collection of disease specific or general healthcare management applications and patients can install other third party healthcare applications on specialized healthcare operating system 50.

Specialized healthcare operating system 50 may also be a platform for healthcare management applications provided by third party vendors. Using the pre-existing software components natively embedded inside specialized healthcare operating system 50, e.g. 54 (FIG. 3), developers can achieve standard medical data exchange, interoperability and communication with medical devices 20.

Referring now to FIG. 6, an exemplary interface to healthfolio 31, healthfolio 31 comprises an individualized, user specific health portfolio detailing information deemed relevant to a desired condition, e.g. heart health such as historical and current characteristics of patient 1. For example, healthfolio 31 contains baseline health data and current health status data of patient 1 and may comprise one or more of the following: past medical history information, e.g. for patient 1, demographic data, past medications, past surgical interventions, past physician claimed diagnoses, and customized risk factors portfolio; family history of hereditary or congenital diseases and/or certain healthcare conditions; history of allergy to any substance or medication; current health and bodily status, e.g. baseline vital signs, baseline Blood Pressure records, a record baseline resting ECG, a record baseline exercise ECG, a baseline chest X-Ray and panorama dental view, a recorded baseline heart and respiratory rate, baseline personal signs and symptoms; medication history; physicians claimed diagnosis and physical findings records; medical diagnoses certified by physicians; and current physical exam findings certified by physicians.

These data may be gathered and stored in a database for each patient 1, such as heartfolio database 30 resident in persistent data store 7. Additionally, these baseline health data may be disease specific and personally customizable. In a currently envisioned embodiment, a template for healthfolio 31 and its baseline health data may be made available for predetermined diseases and can be further customized by authorized users to personal health condition.

Healthfolio 31 may include an interface such as a displayable interface on output device 8 (FIG. 1) which permits gathering information relevant to previous and current heart and general health condition of patient 1. Healthfolio 31 information may be gathered during an enrollment of patient 1 prior to an acute cardiac event and, in a preferred embodiment, is stored in a relational, HIPAA compliant, secure database, e.g. heartfolio database 30. Additionally, healthfolio 31 information may be gathered during alternative means such as interactively over data network 100 to remote service 3, where remote service 3 may comprise a web page form, human operators at remote computer location 19 (FIG. 1), or the like or combinations thereof.

Heartfolio database 30 (not shown in the figures) comprises a database which stores and retrieves medical information for patient 1 which may include physiological data obtained through medical device 20 (FIG. 1), clinical information, family history, laboratory data, drug history, a base-line ECG and historical medical history for patient 1. These data may be used for analysis and future reference, and may be stored in a secure, HIPAA compliant relational database. The data may be made available through secure channels such as over data network 100 to physicians and healthcare providers for patient 1 for further reference and analysis.

Additionally, heartfolio database 30 may be used for further research, epidemiological surveys, and also future management of patient 1. For example, heartfolio database 30 may be used in part by personal healthcare management system 10 for early risk stratifying of chest pain for patient 1. Heartfolio database 30 may further comprise a plurality of measurements for patient 1, e.g. serial ECGs for patient 1 which may be used for risk stratification and diagnosis of the silent ischemia and myocardial infarction.

Personal healthcare management system 10 is capable of logically binding more than one instance of healthfolio 31 into a health status compilation process and extracting family based, genetic, or hereditary traits or epidemiological and environmental findings from health data acquired from family members or community members. Accordingly, it provides more robust and specific data collection means in a family or community basis.

Heartfolio database 30 may also be used to maintain a transmittable data repository of actual base-line data that is not available in the hospital setting and may also accessible through secure data communication channels for use by physicians, health care providers and other users authorized by patient 1.

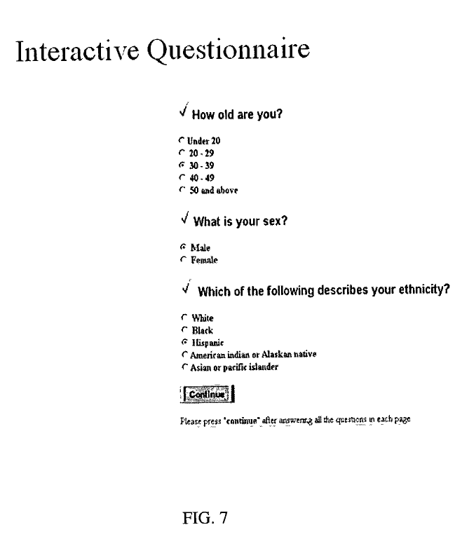

Referring now to FIG. 7, an exemplary interactive questionnaire, interactive questionnaire 40 is presented to patients 1, such as on output device 8 (FIG. 1), to obtain necessary information for instant risk stratifying of heart attack. Alternatively, interactive questionnaire 40 may be presented orally such as by remote service 3 (FIG. 1). Additionally, interactive questionnaire 40 may also be accessible through data network 100 (FIG. 1) such as by using a browser, touch tone telephone system, instant messaging, and the like, or combination thereof. In currently envisioned alternative embodiments, interactive questionnaire 40 may be integrated into a kiosk such as an automated teller machine (ATM) or may available to patient 1 by telephone such as via remote service 3 (FIG. 1).

Interactive questionnaire 40 may be based on physician designed interactive medical questionnaires for gathering symptoms and clinical information for patient 1. Patient 1 utilizes interactive questionnaire 40 to provide information concerning major signs and symptoms, current and past medical information, and other pertinent medical data for patient 1. In a preferred embodiment, interactive questionnaire 40 is interactive. Based on answers provided by patient 1, personal healthcare management system 10 can use interactive questionnaire 40 to provide targeted relevant questions for acquiring additional useful clinical data.

In a preferred embodiment, interactive questionnaire 40 utilizes a multi-media enriched interface which may include access via numerous functionally equivalent methods, e.g. mouse clicks, touch screen, and speech recognition technology.

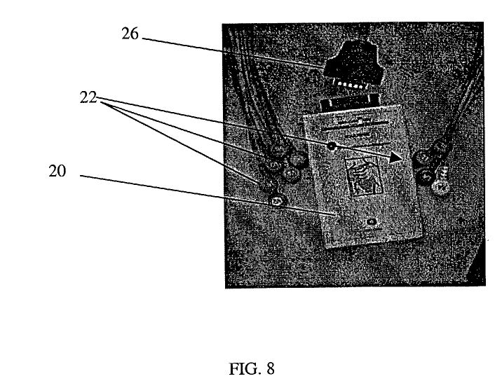

Referring now to FIG. 8, medical device 20 is operatively in communication with computer 11 (FIG. 1), such as via one or more serial, parallel, infrared, USB, or IEEE 1384 ports or the like or combinations thereof. As used herein, medical device 20 may comprise a monitoring device, a non-invasive cardiopulmonary monitoring device; an ECG; an EEG; a BP monitoring device; a peak flow meter; an audiometer device; a digital PH meter, e.g. for vaginal, urine, and/or dental exams; a thermometer; a stethoscope; a breast examination device; a cardiac enzyme tester; a digital biochemical, physiological and biological laboratory tester, e.g. immunoassay, serologic test, blood cell counts and characterizations, genetic screening tests, biochemical tests, tumor markers, hormonal test, antibody tests, blood gas test, and the like; and a plathysmography device.

In additional, in some embodiments medical devices 20 have a graphical or video output port, an audio output port, or the like, or combinations thereof.

Data may be output to and/or accepted from numerous other healthcare devices capable of supporting a digital or analog interface such as by use of a specific driver 53. These may include medical or paramedical treatment or intervention devices; transcutaneous nerve stimulators; massagers; thermal therapy devices; injectors; pain relief technique devices; muscle, nerve and skin stimulators; therapeutic devices which can be used by computer assistance at home; or the like; or combinations thereof.

Medical device 20 is used for acquisition of physiological data, e.g. ECG, heart and respiratory rate, blood pressure, and PO₂, from patient 1 (FIG. 1) and transferring data to Personal healthcare management system 10 for managing patient 1. Medical device 20 may be a plurality of such devices.

Medical device 20 may be a commercially available or a proprietary device which, in a preferred embodiment, comprises a ECG system for acquiring heart signals. Additionally, medical device 20 may be external to computer 11 (FIG. 1) or internal to computer 11. Data representative of these signals may be integrated using an internal component of a computer 11 or provided via an external connection to computer 11. The external connection may be accomplished through any available data port or by a specially designed connecting device able to handle specialty devices such as medical devices 20.

As used herein, “medical device” may further comprise proprietary engine software 24 (not shown in the figures) and connecting media 26.

Proprietary engine software 24 enables acquisition, storage, processing, retrieval, and transferring of data to personal healthcare management system 10. Proprietary engine software 24 may compress the data for faster transportation of the data. Additionally, proprietary engine software 24 may be used to interpret data, analyze the input data, and provide output to patient 1, e.g. showing the results, giving feed back to patient 1, and providing medical instructions to patient 1. Proprietary engine software 24 may also provide personalized, individualized health management for patient 1 using computer 11.

Connecting media 26 connects medical device 20 to patient 1 to acquire physiological data from patient 1. Connecting media 56 may comprise a commercially available device, including electrodes, or a proprietary device such as a body wrap or article of clothing into which one or more sensors 22 and/or medical devices 22 have been embedded. Connecting media 26 may be used to send acquired physiological data through data network 100 (FIG. 1) in numerous functionally equivalent methods, e.g. wired or wireless methods, using numerous signaling protocols such as through the Internet, telephone, wireless media, satellite systems, and the like.

Referring generally to FIG. 9 and FIG. 10, embodiments of a integrating device 16, integrating device 16 comprises a portable device providing one or more data communication channels, generally referred to by the numeral “70,” which can accommodate digital and/or analog data generated by medical devices 20 (FIG. 1) to personal computer 11 (FIG. 1), data network 100 (FIG. 1), or a combination thereof.

Personal healthcare management system 10 may be designed and manufactured in variety of generic types and shapes to achieve portability, customizability, and affordability. In a preferred embodiment, computer 11 is made in one of several configurations, including desktop, a laptop computer, or a handheld device. In currently envisioned alternative embodiments, personal healthcare management system 10 may be built into a home appliances or furniture, e.g. part of a television or a couch. For example, a couch may combine personal healthcare management system 10 with a traditional couch to provide a combination of a full-featured personal computer 11, a plurality of medical devices 20, and a couch to further facilitate the use of variety of home based medical devices 20 along with a full-featured personal computer 11 at home. Similarly, another further embodiment of personal healthcare management system 10 can be integrated into a bed, e.g. a bed with a specialized built-in personal healthcare management system 10 and variety of bedside monitoring devices 20 including heart and respiratory monitoring devices 20 for disabled or debilitated patients 1 or patients 1 needing medical supervision.

Personal healthcare management system 10 may further comprise:

a dynamic medical record definition tool allowing for generating disease based medical record system, personally customized questionnaires and data entry forms. Healthfolio 31 may also be defined and customized by use of the dynamic medical record definition tool.

a personal report builder such as a tool that uses structured query language and a graphical user interface to build a personally customizable report, based on the health data in medical database engine.

a registrar to register a medical contacts or a healthcare directory service, which may include the ability to indicate a preferred schedule and type of communication, with which specialized healthcare operating system 50 may automate communications with the medical contacts and healthcare directory services.

a healthcare actions definition tool to define a predetermined function, e.g. starting medical device 20, a questionnaire, or it can be starting a teleconferencing session with a said medical contact.

a healthcare events definition tool for healthcare events which may arise when an MLM detects a predetermined health condition while monitoring health data.

a notification message definition tool by which a user can modify and customize the type and contents of notification messages, e.g. one can change a text popup message to a prerecorded voice message in case the patient is an elderly or debilitated.

a personal security tool to allow assignment of a specific access key for patient 1 for a predetermined set of executable functions and components

a add-in manager by which integration of new software components to the previously existing configuration may be managed

a personal organizer to receives input data used to organize personal events, appointments, and important dates for patient 1 wherein such information may be used by other components of healthcare specific operating system 50, including GUI 80 and its profiles and interface logic.

specialized tools such as a drug dispensary configurator to configure and personalize the functions of electromechanical drug dispensary device according to personal healthcare condition.

In the operation of an exemplary embodiment, a predetermined set of basic input/output system routines are initiated, after which specialized healthcare operating system 50 scans a predetermined set of data ports for the existence of a medical device. Upon detection of medical device 20, specialized healthcare operating system 50 initializes a driver for medical device 20 thus providing access between the predetermined set of basic input/output system routines and medical device 20. The scanning may continue while specialized healthcare operating system 50 operates, allowing addition or removal of medical devices 20.

Concurrently, specialized healthcare operating system 50 initializes GUI 80, where GUI 80 executes in computer 11 and interfaces to the predetermined set of basic input/output system routines. GUI 80 continually determines a status of a predefined health status condition of patient 1 at predetermined intervals. Using the status, GUI 80 mutates one or more desired mutatable characteristics of a displayed graphic user interface element.

Additionally, using a health plan and schedule specific to patient 1, health-specific GUI 80 forms a health portal that provides patients with the health objects he needs to successfully follow his health plan and reach to his medical goals and milestones defined by physicians. A healthcare portal collects a predetermined set of healthcare related functions available through specialized healthcare operating system 50 itself or via communications link 12 (not shown in the figures) to such as via the Internet. Specialized healthcare operating system 50 provides a thorough and comprehensive demonstration of patient's current health status based on the accumulated health data over times and the baseline health data. Specialized healthcare operating system 50 may use a disease based and personally customizable engine of then current best medical and clinical practice algorithms and physician driven management protocols to compile submitted health data for patient 1 into a concise medical report showing the current health condition of patient 1 and the progress and presentation of disease or health condition of patient 1.

One or more medical or paramedical therapeutic services can be provided by specialized healthcare operating system 50 on an out-of-hospital basis. Using specially developed applications and medical devices 20 attached to the specialized healthcare operating system 50, one can personally manage medical or paramedical services at home, e.g. thermal therapies, massages, transcutaneous nerve stimulations and other pain relief techniques, controlled automatic injections, and the like. Specialized healthcare operating system 50 can also provide a comprehensive home based medication and prescription management and audit system.

Specialized healthcare operating system 50 may be used to automatically recognizes if peripherals such as medical devices 20 or intermediary devices, e.g. 17, are attached to computer 11, as well as automatically recognize multi-channel data input from such medical devices 20. Specialized healthcare operating system 50 can also automatically recognize if any of medical devices 20 are attached to an ordinary PC through one of standard input/output ports, e.g. serial, parallel, USB, and the like, and may initialize and work with such attached medical devices 20.

Using medical devices 20, specialized healthcare operating system 50 can collect healthcare data for patient 1, including medical devices 20 operatively in communication with specialized healthcare operating system 50 over data network 100. For example, applications using specialized healthcare operating system 50 may gain access to one or more comprehensive collections of standard medical knowledge bases useful in covering standardized medical knowledge bases in the healthcare and medical fields, pharmacy, healthcare, dentistry, clinical and basic sciences, nutrition, and the like. Additionally, specialized healthcare operating system 50 may further contain a comprehensive collection of shareable components and assemblies that provide standard software libraries for building medical and healthcare applications. In a currently envisioned embodiment, specialized healthcare operating system 50 may synchronize or replicate medical data with other standard medical database engines such as through data network 100, e.g. automatically initiate such synchronization when the connection to data network 100 is established or initiate upon a user demand or via a scheduled update.

Accordingly, interfaces and applications to provide interactive communication with medical devices 20 to acquire medical and health data may be provided. By allowing for medical data communication between diverse software platforms based on existing medical data exchange and messaging standards, these interfaces and applications may provide functionality required to store, search, retrieve, and present medical data in conjunction with international health data management standards and medical data modeling and/or functions useful for communication of medical data between healthcare communication networks with hybrid architectures (clinical or administrative medical information networks) based on the existing medical and electronic data interchange standards.

In a currently envisioned embodiment, specialized healthcare operating system 50 may be used to provide a standard platform to support creating, updating, and implementing a variety of medical logic modules (MLM), e.g. by providing interfaces and functions based on existing standards and syntaxes. The MLM may be used to provide a comprehensive collection of disease based healthcare management modules based on best medical practice algorithms and physicians driven protocols. MLM is customizable and can be reused by diverse applications. Additionally, MLMs may be updateable through data network 100 to provide the state of the art best medical practice algorithms and management protocols such as for health data analyses and compilation of healthfolio 31

Specialized healthcare operating system 50 may also provide healthfolio 31 integration interfaces, e.g. one or more MLMs based on best medical practice algorithms and physician driven protocols that can be used to compile submitted health data into a concise medical report showing the current health condition of patient 1 and the presentation and progress of the disease.

Specialized healthcare operating system 50 can also provide a well equipped communication platform for health monitoring and management from a remote site for healthcare workers and medical contacts. For example, specialized healthcare operating system 50 can automatically record monitoring and measurement data and log events, messages and notifications sent or received by specialized healthcare operating system 50.

Physicians and other healthcare workers can employ a specially designed communication toolbox such as through a health object introduced by health-specific GUI 80 to communicate with patient 1, monitor health data from one or more multiple patient 1 online, remotely configure a health-plan for one or more patients 1, and the like, and combinations thereof. A communication toolbox may also be used as a platform for data exchange between medical contacts, e.g. communication between physicians and healthcare providers or remote consultations between physicians or physicians and nurses are supported by specialized healthcare operating system 50.

Specialized healthcare operating system 50 can provide an standard platform for peer to peer communication between groups of patients 1 and between patients 1 and selected others such as relatives.

Additionally, the present invention provides for collective and interoperable healthcare management applications developed in software platform. All of the applications below may be developed using shared software components and application programming interfaces and be interoperable with any other application so built:

A system of personal healthcare planning and programming wherein the software system for healthcare planning and programming is disease specific and personally customizable. For example it can be a Healthcare planning software for asthma, diabetes, seizure, thyroid gland dysfunctions, and the like.

A system of medical data acquisition which starts, controls, and ends data acquisition from one or more medical devices 20 to simultaneously acquire data from diversr data sources like cardiopulmonary monitoring devices, digital biochemical and physiological kits, interactive questionnaires and alike. It can also provide a graphical interface to controls and configure available medical devices 20 and healthcare questionnaires.

A system of medical records and healthfolio 31 compilation wherein the medical record may be a multimedia enabled comprehensive electronic medical record system coupled with database means and both healthfolio 31 and the medical record are disease specific and can be personally customized to individuals' healthcare condition.

a system of health status analyses, e.g. using MLMs to monitor, process, and compile online and saved health data and to perform real-time risk stratification and dynamic risk assessments over real-time health data to detect health events. For example, an MLM engine processes and compares the online input data against baseline data for patient 1 and concludes the current health status of patient 1 and detects health care events and reacts appropriately.

A system of smart medication and prescription management which can be coupled with an electromechanical drug dispensary means.

A system of remotely programmable appointment scheduling that provides a comprehensive medical appointments organizer and reminder system.

A system of medical contacts management that provides an interactive communication platform for online and offline communication with subscribed healthcare contacts such as physicians, healthcare facilities (clinics and hospitals), relatives of patient 1, other patients having the same medical condition or common healthcare interests, and the like through data network 100.

A system of medical and healthcare education which provides an interactive and multimedia environment for disease specific, personal, and family education, emergency medicine education, and first aid education, and which may further comprise programmable health specific search engines and frequently asked question update systems integrated into the system.

A system of health directory search services coupled with GUI 80 to provide a health portal.

A remotely accessible source for medical contacts which are qualified to gain access to certain health data of patient 1 through remote access functions for medical contacts, e.g. medical contacts can monitor, control and configure healthcare plan of patient 1 or interactively communicate with patient 1, wherein medical contacts can comprise a physician, nurse, healthcare facility like a clinic or hospital, healthcare provider like an insurer, a pharmacy, a relative of patient 1, another patient 1 having the same disease or similar healthcare conditions, or any other authorized entity qualified to have a healthcare oriented contact with the patient, or the like.

A system of nutrition and lifestyle management which provides nutritional consultations and calculations and provides a disease based comprehensive knowledge base of nutrition and lifestyle modification programs and protocols.

A system for medical and paramedical treatment assistance at home wherein specialized healthcare operating system 50 can manage medical or paramedical devices 20 attached to computer 11, and run appropriate medical assistance applications to assist at home or other non-hospital located patients 1 doing physiotherapeutic or any other medical procedure.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1. A healthcare specific computer operating system for a computer system, comprising:
a. a predetermined set of basic input/output system routines;
b. a driver for a predetermined medical device, the driver providing access between the predetermined set of basic input/output system routines and the medical device;
c. a healthcare engine comprising a healthcare related software component; and
d. a graphical user interface executing on the computer system to provide an interface to the predetermined set of basic input/output system routines, the graphical user interface capable of mutating a desired mutatable characteristic of a displayed graphic user interface element based on a predefined health status condition of a user of the healthcare specific computer operating system.

2. A method of providing operating system functionality for a healthcare specific computer operating system for a computer system, comprising:
a. initiating a predetermined set of basic input/output system routines;
b. scanning a predetermined set of data ports for the existence of a medical device;
c. initializing a driver for the medical device upon detection of the medical device, the driver providing access between the predetermined set of basic input/output system routines and the medical device;
d. initializing a graphic user interface, the graphic user interface executing on the computer system and interfacing to the predetermined set of basic input/output system routines;
e. determining a status of a predefined health status condition of a user of the healthcare specific computer operating system; and
f. mutating a desired mutatable characteristic of a displayed graphic user interface element based on a predefined health status condition of a user of the healthcare specific computer operating system.
